(19) United States
(12) Patent Application Publication
(10) Pub. No.: US 2010/0266996 A1
(43) Pub. Date: Oct. 21, 2010

(54) Method for teaching a second language using an infant situational approach (D-Blok)

(76) Inventor: Gerald Burrage, Quebec (CA)

Correspondence Address: Gerald Burrage, a/s M Carrier, 3107 avenue Hotels, Quebec, G1W4W5, CA

(21) Appl. No.: 12/383,803

(22) Filed: Mar. 30, 2009

(51) Int. Cl. G09B 19/06

(52) U.S. Cl. 434/157

(57) ABSTRACT

D-BLOK is the name for an oral language teaching method that creates an environment to facilitate oral communication for:
a. People that are just beginning to speak a second language.
b. People that are not confident speaking a second language but have some knowledge of that language.
c. People with oral communication problems in first or second language.

### FIELD OF THE INVENTION

The present invention relates to a teaching method used to facilitate oral production of a first or second language.

### DESCRIPTION OF PRIOR ARTS

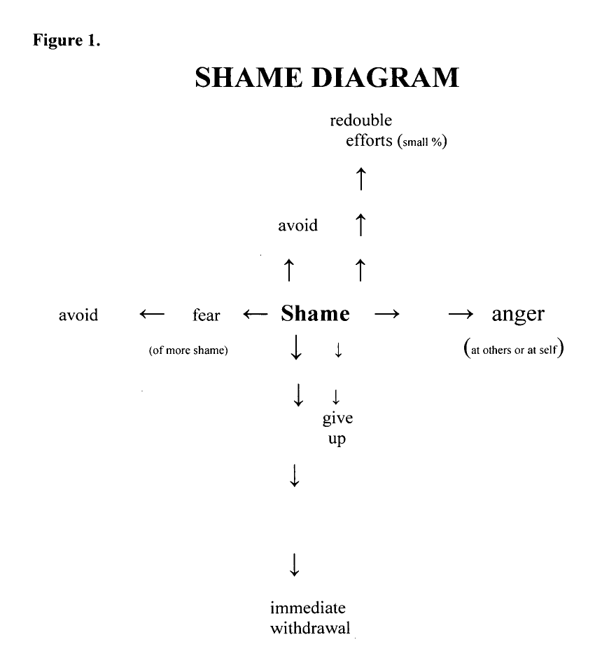

Language learning is as old as language itself on the planet. Man has always communicated one way or another but verbal communication evolved in early man to become the easiest and simplest form. Men didn't actually concentrate on the method of learning a language until they began to use written communication. Grammar translation was the first method of becoming familiar with another language. Unfortunately it didn't help oral production very much. Many translators could translate easily from one language to another but could not actually speak the language. Just before the turn of the 20th century Charles Berlitz noticed that his students were speaking freely in conversation and seemed to be quite happy trying to converse without the use of grammar books and rules. With the advent of the second world war the scientific community battled between Noam Chomsky's “black box” theory which was noncognitive and Skinner's behavioral theories involving cognition. Since the Second World War there have been many theories put forth regarding oral production. Steven Krashen in the 70s and 80s put forth a number of theories regarding how children learn first language and that the closer that the conditions are to the situation in first language, the better the student learns language. Thomas Cook, working with Krashen, put forth a theory of shame in the 90s which is directly related to language learning. (See FIG. 1 diagram)

### BACKGROUND AND SUMMARY OF THE INVENTION

Second language learning has never been easy for students. This is not surprising considering that speaking is the most complicated thing that we do in life every day. The problem is we just don't understand how complicated it is. Of course we learned our first language when we were very small so we have forgotten the many thousands of mistakes that we made when we were young and never think about the mistakes that we make in present day. The mistakes we make on a daily basis are quickly and easily corrected and immediately forgotten. This is not the case however with second language. Anyone who can logically reason or has cognitive powers will tell you that learning a second language is a painful experience where the student is subjected to many undesirable emotions such a shame leading to anger, frustration, feelings of worthlessness, disappointment and the list goes on. Students are under the impression that second language is just another subject like mathematics or history and that they should be able to master new subjects like any other subject.

As adults, we have expectations of ourselves. We expect ourselves to be able to understand reasonably difficult problems and to master the various enigmas and conundrums that crossed our path in daily life. As adults we are mature and we can handle the emotional difficulties of going to school and getting through difficult learning situations. But when it comes to second language we realize one thing. We can't handle the shame and all of the other negative emotions that come with second language learning. This is why such a small percentage of the world is bilingual. For most people it's simply not worth it.

When I started teaching second language I realized that my students were under a great deal of stress. As a person who had already learned a second language and was working on his third language I fully understood the kind of stressed that people were undergoing. But like most second language teachers I thought that this was simply something that we had to undergo and that there was no other way to do it. When I was in second language school I saw many people cry as well as many angry students. But in the end students tried to pick themselves up as best they could, dusted themselves off, and tried to make progress. In the end most students simply gave up.

It all began several years ago when I started to call my students children. I'm generally not in the habit of calling adolescents and adults children, and I'm not really sure why I did it the first time. What I didn't realize for the first three or four months was that my students not only did not mind being called children but that they actually rather enjoyed it. This was puzzling to me. After all, most adults or adolescents would like to think of themselves as mature and grown-up. We all like to think of ourselves as being responsible human beings. But with all that tension in the class, it seemed to give them comfort. I continued with the children theme and began to call my students “crazy kids”. This relaxed them even more.

The name of the method is called D-BLOK. This is in no way an accident. The phonetic name comes from the French verb débloquer. When small children begin to emit sounds, they experiment a great deal. This kind of experimentation is vital to successful language production and learning. Oral language production is very complicated but the average human being doesn't think about oral communication that way. Most human beings prefer to think that they can speak very well to each other and have few communication problems orally. But if we actually kept a record of all of our language mistakes on a daily basis, we would probably be quite surprised at the number of errors. The pathways between the brain and the mouth and the vocal cords are long and easily fall prey to circumstances which prevent successful execution of what we would like, to transmit orally. Add onto that the enormously complicated nerve transmissions that are necessary to operate the mouth, throat, vocal cords, and breathing operations and you have potential for many kinds of problems. For most students of this type of experimentation is so intimidating and frightening that they are unable to even try to communicate in a second language. Even those people that try are often discouraged by the results and are even more fearful of criticism from their peers and the teacher.

D-BLOK relaxes students to the point where they are able to freely experiment in exactly the same fashion as small children who are just beginning to learn the language. Without this type of experimentation with sounds, word combinations, and thought coordination it would be impossible for a student to become an efficient oral communicator. D-BLOK only concentrates on oral communication material that is important to students. This is vital because children learn their first language by reacting to their social environment which surrounds them.

I have worked at Berlitz Language School where the new school in question has its own oral method as well as reading and writing methods. In all of my other teaching situations the concentration has generally been on written output. This was puzzling to me because we really need to speak languages with writing being a secondary and more minor form of communication. I had never really had great success with oral production and had never talked to students who experienced success with oral production.

After studying Steven Krashen's theories coupled with Thomas Cook's theories about shame, I began to realize that treating adults like children was the only logical way to teach language. In the first six months of testing the theories I realized that every single adult and adolescent was extremely comfortable with the idea of going back to the age of one to two years old. I did not expect that type of reaction. At that particular time I did not really understand how to explain what I was doing to the students. After three weeks of this type of rough theory the students began to speak in conversation. They were extremely relaxed because they realized that as children, there were no consequences for mistakes. I had an extremely high attendance rate and the progress was shocking. I realized that this was a life-changing event for these people and that they were very excited. After tinkering with the method for another 12 months most of my students begin to speak in conversation after one week. As students become more relaxed, they begin to speak more. This leads to confidence and greater results. Results are really the bottom line for the students but of course their course is much more enjoyable.

### DETAILED DESCRIPTION OF THE INVENTION

The method is very simple. It is necessary to reinforce the idea that the students are very young children with extremely limited cognitive powers. This means that every time they produce an oral communication the teacher will be very happy. Students are also taught that criticism from each other prevents them from learning a second language. This creates a very strong bond between students. In this situation there is limited correcting done by the teacher. The reaction of the teacher is always positive. As Krashen has noted, many students begin to correct themselves after making an oral mistake a few times. In many cases it is not necessary for the teacher to correct the students. The teacher will merely suggest corrections from time to time. It is also very important that the teacher reinforced the idea that questions are good, but there are no ridiculous questions, and that this is how children learn a second language. It is also very important to speak to adults in their first language at the end of the lesson as if they were children because some students do not always understand D-BLOK theory immediately. This double reinforcement of the idea in their first language and second language builds an unbreakable bond between the students and the teacher. I would almost venture to say that some of my students develop a very strong bond of confidence almost resembling a parental figure. Reinforcement of this idea must take place many times during a daily teaching. There is no such thing as too much reinforcement in this area. Once confidence has been established between the students and a teacher, the teacher may reduce this type of reinforcement but only slightly.

The other part of the method entails two ideas: risk and failing. Students are taught to take as many risks as possible because failing leads to enormous success in second language. Once again the teacher explains that children fail enormously when they try to say things orally. This is something that we have all forgotten as adults. When we were young we babbled, became very confused, and there were simply times when we were tongue-tied and couldn't say anything. When students fail they are congratulated because they tried something new. This is something that in many cases runs contrary to what they are taught in every day school classes. Once this idea of not being allowed to fail is broken, the students become extremely vocal. At this point they begin to experiment with sounds, breathing techniques, and word combinations.

This method works best with groups of eight to twelve people. This generally runs contrary to the belief that a private lesson would lead to greater results. Teachers tend to correct students immediately when they make a mistake. I firmly believe that this is harmful to the progress of the students. In this method students work in teams discussing how to describe, fix, and present problems or situations. Because students are all working together they become exposed to many different types of words, phrases, accents and pronunciations. This helps them to self correct and to absorb and learn many different expressive points of view. They are also much happier speaking with each other than directly with the teacher. The teacher is always in the area but only there to be consulted with in times of need.

All students are assigned a reading program. Once students begin to speak they must improve their vocabulary and structural skills relating to subjects that are interesting and important to them. This is how children learn languages. Children only speak about what is important to them and would not be easily convinced to speak about things they don't care anything about. When students have a reading program that is interesting for them no matter what the subject, enormous oral results are produced. Many students have to be taught that reading is fun. This is another integral part of the D-BLOK theory. Once students are convinced by the teacher that speaking is fun, then that confidence is easily transferred to the reading program. The biggest problem is convincing the students to begin with children's stories, comics and other very easy reading. Many students think that because they are adults they need to read adult novels. This is another frustrating factor that often leads to students abandoning their language program.

D-BLOK also refrains from grammar lessons. Grammar is used in D-BLOK but in extremely short bursts of five minutes or less. English teachers often don't understand the phonology or the mental representation of sounds that are produced by humans. In many cases teachers actually lie about the sounds that they make. Examples of phonological flapping where the letter t is actually pronounced like d as in the word water, are numerous in any language. Students are constantly being misled about the sound that they should produce because they are influenced by grammatical spelling and grammar rules regarding certain prefixes and suffixes. Children are under no such influence and easily learn pronunciation because there are no negative influences such as spelling or grammar rules. Students have constantly been conditioned to visually examine spelling and grammar as a way of learning a language but human beings often produced sounds that are completely different from spelling or morphological word additions.

The FIG. 1 schematic is Thomas Cook's wheel of shame taken from his paper entitled A Study of Shame and Excitedly in an English Language Learning Situation shows the unavoidable negative consequences that shame produces. Shame Diagram Explanation: Shame is a condition resulting from situations where students are expected to perform tasks successfully but fail. In the minds of the student and surrounding students and professor, the failure results in negative, discouraging and unhappy sentiments linked with anxiety which we learn to feel when we fail cognitively. Students feel inadequate, less intelligent and even ridiculous when they do not perform the way they think they should, resulting in the state of mind of shame.

Shame and its state of mind lead to other secondary conditions such as fear leading to avoidance of the subject being studied by the student as is shown on the left of the diagram. This avoidance of the subject is caused by a fear that more shameful situations will occur as a result of failure. Shame also produces a reaction of immediate withdrawal from any situation regarding the subject being studied or the student decides immediately that the process is simply beyond his/her learning capacity and gives up as is shown on the bottom of the diagram. Shame also produces anger at oneself and surrounding students and teachers as a result of unexpected failures as is shown on the right side of the diagram. Shame results in avoidance as the student becomes indifferent. A small percentage of students redouble their efforts to successfully perform the task as is shown on the upper portion of the diagram.

Shame and its direct link to anxiety as well as all of its secondary effects such as avoidance, fear, withdrawal, anger, indifference, and giving up paralyzes the students when trying to produce oral messages. Shame must be taken out of the teaching equation regarding oral production if the student is to have a positive result. While the process of learning vocabulary, grammar, and phrases is generally cognitive, the process of taking that information and producing a logical, oral message in a situational context is probably not cognitive. Because society thinks of speaking as a cognitive action, students are given situations where they are expected to orally reproduce information learned cognitively in second language. This is an impossible task as failure is not only imminent but necessary in order to improve oral production. But students have been conditioned to feel shame and guilt when they fail cognitive tasks, not realizing that oral production is not cognitive. It is not an accident that babies experiment with sound, word and sound order, pitch, and oral messaging all day long that produce for the most part completely unintelligible babble without feeling any shame whatsoever. This type of environment is essential for second language students. Because oral production is not a cognitive act and extremely complicated, the failure rate is very high and must be treated like success, which is what we do with babies. The action of speaking is so complex that human beings could not possibly think about all the co-ordination necessary in the body to produce even the simplest of messages. People often think one thing but something else comes out of their mouth, often without them knowing it. Humans constantly miscommunicate on a daily basis in their first language but rarely notice these mistakes as they are easily corrected without shame or notice. The fact that humans are poor communicators, fail numerous times daily, and can feel the effects of shame and its secondary effects in the case of major social blunders leads one to believe that oral production is an act that humans can only partially control.

Students must have an environment completely free of shame, the risk of shame, anxiety, and its accompanying factors as is shown in the diagram. Students must be able to fail freely and take risks without negative, shameful consequences. This kind of experimentation is vital because students cannot blame themselves for failing a task that they will probably fail and must fail numerous times in order to improve, as very small children do.

1. A teaching method called D-BLOK where the students are given verbal stimuli, reinforcement and directives in order to transition them back to the age of approximately one to two years old when cognition is just starting to develop.

2. A method as claimed in 1 where the teacher constantly reinforces the fact that students are at the age of one to two years old and that there are no negative consequences for their actions, stressing that all oral experiences are positive.

3. A method as claimed in 1 and 2 where the teacher refers to all students as children no matter what their age is and where students are referred to as “crazy children” or “crazy kids” but never thought of as mature children, adolescents or adults.

4. A method as claimed in 1 through 3 that teaches students various types of children's behavior such as repeating mistakes, forgetting, and resisting change in a positive atmosphere.

5. A method as claimed in 1 through 4 that teaches students how their first language was learned as a child.

6. A method as claimed in 1 through 5 that teaches students that failure leads to success in a one to two year old child in a positive manner.

7. A method as claimed in 1 through 6 that teaches students to ignore any negative commentary regarding their oral language output and that all oral output leads to positive results as is seen in children.

8. A method as claimed in 1 through 7 which relaxes students to the point where their ability to decode oral messages improves enormously.

9. A method as claimed in 1 through 8 where all students have an image which some linguists call “face” which they would like to project to the world and that the face of all one to two year old children is protected.

10. A method as claimed in 1 through 9 where the teacher always speaks to students in their first language treating them like small children.

11. A method as claimed in 1 through 10 where students always work in teams and change team members often.

12. A method as claimed in 1 through 11 where students are assigned a simple children's reading program.

13. A method as claimed in 1 through 12 that positive attitudes and results about speaking lead to positive learning results and attitudes regarding reading programs.

14. A method as claimed in 1 through 13 that oral production is diminished with grammar instruction.
